(19) United States
(12) Patent Application Publication
(10) Pub. No.: US 2019/0083217 A1
(43) Pub. Date: Mar. 21, 2019

(54) Battery-Free Powered Toothbrush

(71) Applicants: Patrick R. TRIATO, Portland, OR (US); Ethan E. VELLA, Portland, OR (US); Michael A. FAIRCHILD, Vancouver, WA (US); Joshua P. YASBEK, Portland, OR (US)

(72) Inventors: Patrick R. TRIATO, Portland, OR (US); Ethan E. VELLA, Portland, OR (US); Michael A. FAIRCHILD, Vancouver, WA (US); Joshua P. YASBEK, Portland, OR (US)

(73) Assignee: Goodwell Inc., Portland, OR (US)

(21) Appl. No.: 16/107,020

(22) Filed: Aug. 21, 2018

Related U.S. Application Data
(60) Provisional application No. 62/559,325, filed on Sep. 15, 2017.

(51) Int. Cl. A61C 17/34; A46B 15/00; A46B 13/08; F03G 1/02; F03G 1/08; F16H 1/28; F16D 7/02; F16D 7/04; A61C 17/22; A61C 1/18

(52) U.S. Cl. CPC A61C 17/3436; A46B 15/0006; A46B 13/08; F03G 1/02; F03G 1/08; F16H 1/28; A61C 2204/002; F16D 7/044; A61C 17/221; A61C 1/186; A46B 2200/1066; F03G 2730/02; F03G 2730/03; F16D 7/025

(57) ABSTRACT

A manually-wound or charged, powered toothbrush includes a winding mechanism, an energy storage element, and an output gear train to cause a rotating, oscillating or sweeping brush head to move, thus improving the efficacy of the user's oral-care regimen.

### CONTINUITY AND CLAIM OF PRIORITY

This is an original U.S. patent application that claims priority to U.S. Provisional Patent Application No. 62/559,325 filed 15 Sep. 2017, whose disclosure is incorporated by reference in its entirety.

### FIELD

The present invention relates in general to power-operated toothbrushes and more particularly to a toothbrush having powered bristle motion wherein the motive force for the motion is provided by the relaxation of a compressed spring.

### BACKGROUND

In order to facilitate hygienic care of the teeth and gingival areas, a variety of power-operated toothbrushes have been developed and are currently available on the market. Typically, these power-operated toothbrushes comprise a battery and an electric motor coupled to mechanical linkages that drive the toothbrush head and/or groups of bristles back and forth, side to side, or in rotating motions to help dislodge plaque from tooth surfaces.

Recent developments in this field have been largely directed to increasing vibration frequencies—“ultrasonic” power brushes are now common. However, other features and characteristics of powered toothbrushes may also be of importance in particular situations. The present disclosure discusses embodiments that are useful in several circumstances.

### SUMMARY

Embodiments of the invention are powered toothbrushes that operate on user-supplied energy. The toothbrushes may have replaceable bristles or mechanical heads, and some embodiments include features to help prevent the user from applying excessive brushing force.

### BRIEF DESCRIPTION OF DRAWINGS

FIG. 1 shows an external perspective view of a preferred embodiment of the invention.

FIG. 2 is a block diagram showing the principal functional blocks of an embodiment.

FIG. 3 shows a partially-exploded view of an embodiment, with a variety of alternate components.

FIG. 4 shows a different partially-exploded view of an embodiment to highlight additional aspects of the invention.

FIG. 5 shows the internal components of an embodiment, arranged as they would be assembled within the housing.

FIG. 6 shows an exploded view of the input gear train of an embodiment.

FIG. 7 shows several views of the energy-storage component of an embodiment.

FIG. 8 shows an exploded view of the output gear train of an embodiment.

FIGS. 9A and 9B show details of a speed limiter or governor that may be used in an embodiment.

FIG. 10 shows details of the brake mechanism of an embodiment.

FIG. 11 shows details of the mechanism associated with the oscillating brush head of an embodiment.

### DETAILED DESCRIPTION

Embodiments of the invention are manually-charged powered toothbrushes. Energy to operate the toothbrush is typically stored mechanically, e.g. by compressing or winding a spring, or by accelerating an inertial wheel, but an embodiment might also use a manually-operated generator to charge a battery, which would subsequently operate an electric motor to drive the brush bristles.

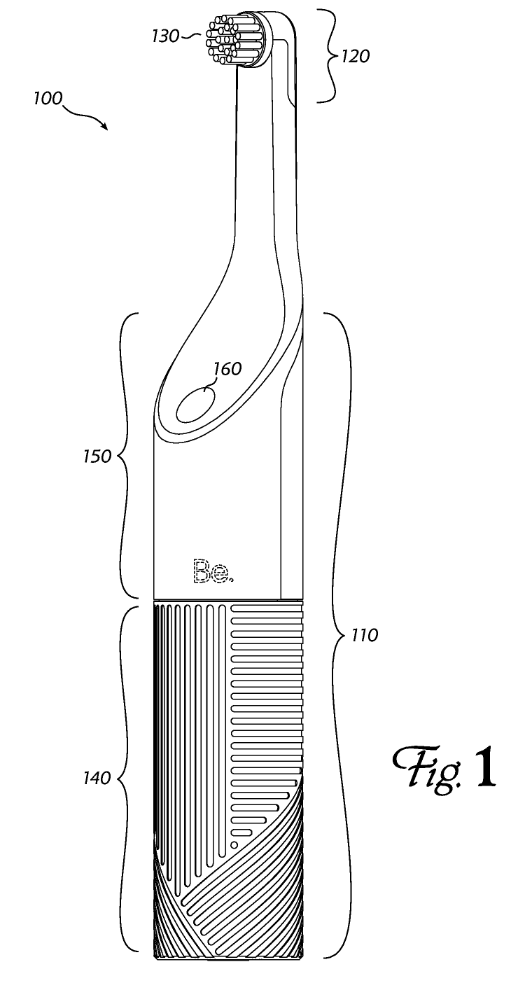

FIG. 1 shows an exemplary embodiment of the invention (generally 100). It comprises a roughly cylindrical body or housing 110: a larger-diameter body portion or “handle,” extending up to narrower head portion 120 carrying a brush 130 for cleaning the user's teeth. The larger-diameter body or handle 110 is divided into two parts 140 and 150, which can be rotated or twisted with respect to each other about a common axis (which is roughly parallel to the cylindrical body).

The body 110 may have a non-circular and/or nonuniform cross-section or a nonlinear central axis (i.e., it may bend or curve somewhat), provided that the internal mechanisms can be accommodated and other operational requirements can be met. Rotation between parts 140 and 150 may be unidirectional or bidirectional, as discussed below.

An embodiment comprises a bi-stable switch 160 to disable or enable the device. The switch may be, for example, a brake that engages an internal mechanism to prevent operation while the device is not in use (including when the device is being charged). When disengaged, the internal mechanisms turn and/or reciprocate to cause the brush to oscillate. Brushes may rotate back and forth around an axis of rotation, move back and forth along an axis of translation, sweep back and forth through an arc perpendicular to an axis of rotation, or make more complicated combinations of these and similar motions, all directed at more efficiently dislodging debris from the user's teeth and gums.

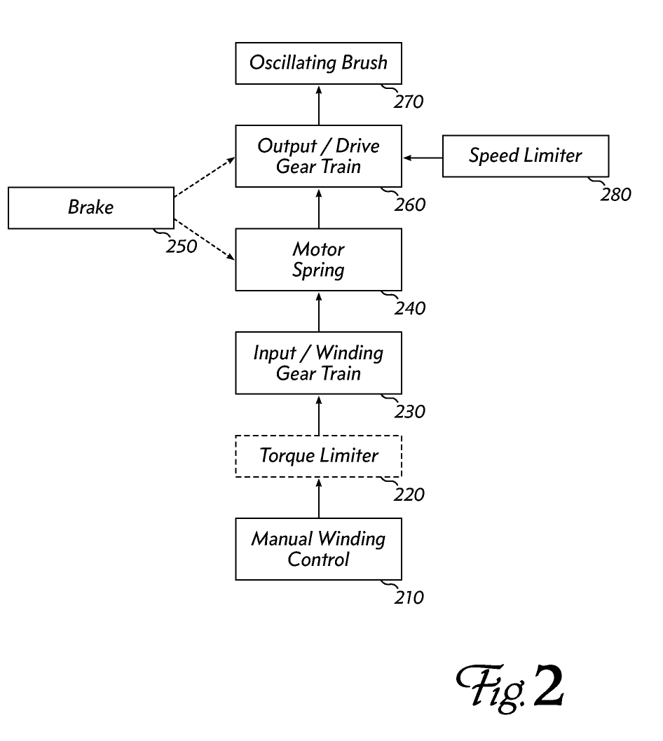

FIG. 2 is a block diagram showing the principal functional blocks of an embodiment. The blocks are arranged from bottom to top so that they are roughly similar in physical arrangement to components in an embodiment of the invention such as FIG. 1. All components are contained within (or at least coupled to) a housing. At one end of the housing, a manual winding control 210 allows a user to charge or accumulate energy in the device, which will be used later during operation. The winding control is typically a rotating device, but an embodiment may use a reciprocating (back-and-forth) motion, a flexing motion, or another suitable motion to charge the energy store.

In a rotating-winder embodiment, a torque limiter 220 may be provided so that the user does not overcharge or overstress the device. A torque limiter may make a noise or display a visual indicator when the device is fully charged.

An input or winding gear train 230 couples the user's input winding action (via the winding control 210) into a suitable motion for charging the energy store. In a preferred embodiment, the user's winding performs work to compress a motor spring 240. For example, motor spring 240 may be a spiral or scroll spring in a cylindrical form factor, where twisting the spring around an internal spindle through the center of the cylinder stores energy in the spring.

A brake 250 may engage with another part of the motor spring 24o or with an output/drive gear train 260 to prevent the energy in the spring from immediately activating the device while the user is charging it. Once a sufficient charge has been applied (e.g., when the torque limiter 220 clicks to indicate that the spring 240 has been completely wound), the device is ready for use.

The user may disengage brake 250, allowing the braked component to operate freely. For example, the motor spring 240 may be freed to uncompress or unwind; or an output/drive gear train 260 coupled to the motor spring 240 may be permitted to move. Motion of the output/drive gear train causes the oscillating brush 270 to rotate, vibrate and/or translate through a reciprocating range. The oscillating brush helps the toothbrush's user to clean his teeth.

In a preferred embodiment, the output/drive gear train will have low friction (to avoid wasting energy from the motor spring). However, such an embodiment may drive its brush to oscillate too quickly, expending the stored energy before the user can complete his brushing regimen. In such an embodiment, it is preferred to include a speed limiter 280. For example, the inertial speed limiter described below can be used to prolong the device's operation at a useful oscillating rate, rather than dumping the full charge quickly in an unhelpfully rapid burst of oscillation.

Next, we turn to the structural details of each functional block, with particular attention to the specific implementation choices of the preferred embodiment.

### Winding Mechanism

The preferred embodiment comprises a rotating winder that can be turned to compress an energy-storage spring. The axis of rotation may be aligned with the central cylindrical axis of the handle body. A curved-handle implementation may be constructed by offsetting and/or angling the axis of winding with respect to the next portion of the body housing (for example, by using a non-collinear gear train or a flexible axial joint such as a U-joint.

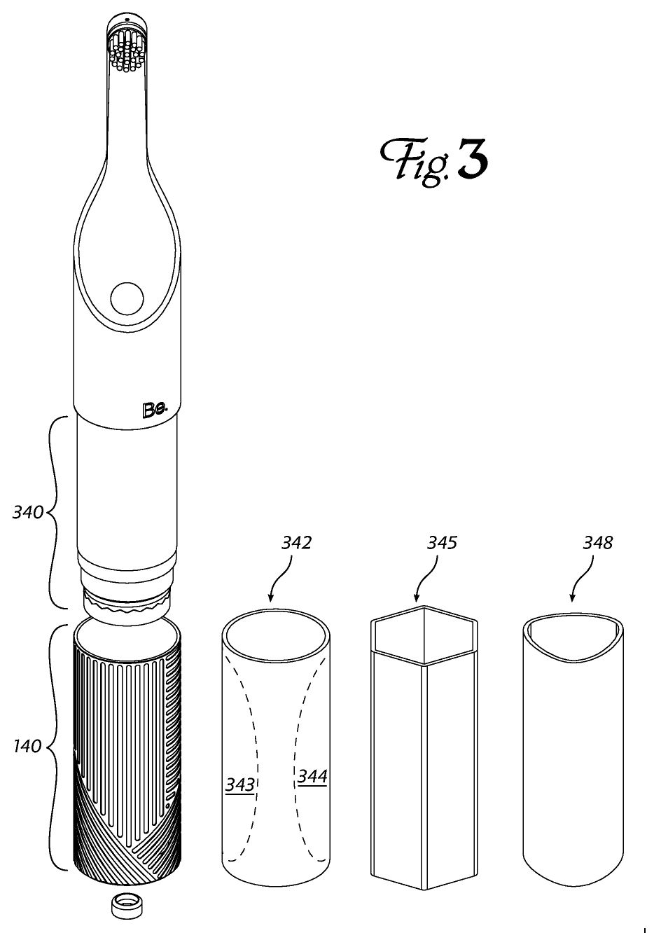

FIG. 3 shows a partially-exploded view of the preferred embodiment of FIG. 1, where the manually-operated winding handle 140 has been moved down to show that it may be constructed as a sleeve or cup over a slightly-narrower portion 340 of the central body. The winding handle 140 may be cylindrical, preferably with grooves, depressions, ribs, bumps or other grip-enhancing features on its surface. Alternatively, the handle 342 may have grippy (e.g., rubber or silicone) patches 343, 344 molded in, or may have a regular shape (e.g., hexagonal handle 345) or an irregular shape (e.g. tri-lobe handle 348).

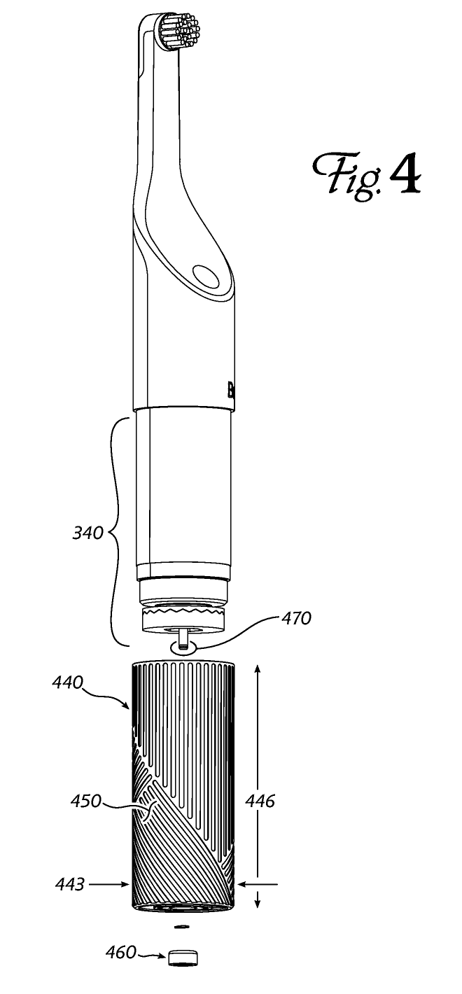

The preferred embodiment (FIG. 4) has a cylindrical winding handle 440 with a diameter 443 between about 20 mm and 35 mm, and a grip (sleeve) length 446 of between 15 mm and 120 mm. To improve the user's grip, the handle's surface comprises molded channels 450. When handle 440 is assembled to the rest of the housing (by sliding it up to cover narrower portion 340 and securing the handle to the input gear train (460, 470), the handle can be rotated to drive the input gear train, as described below.

### Input Gear Train

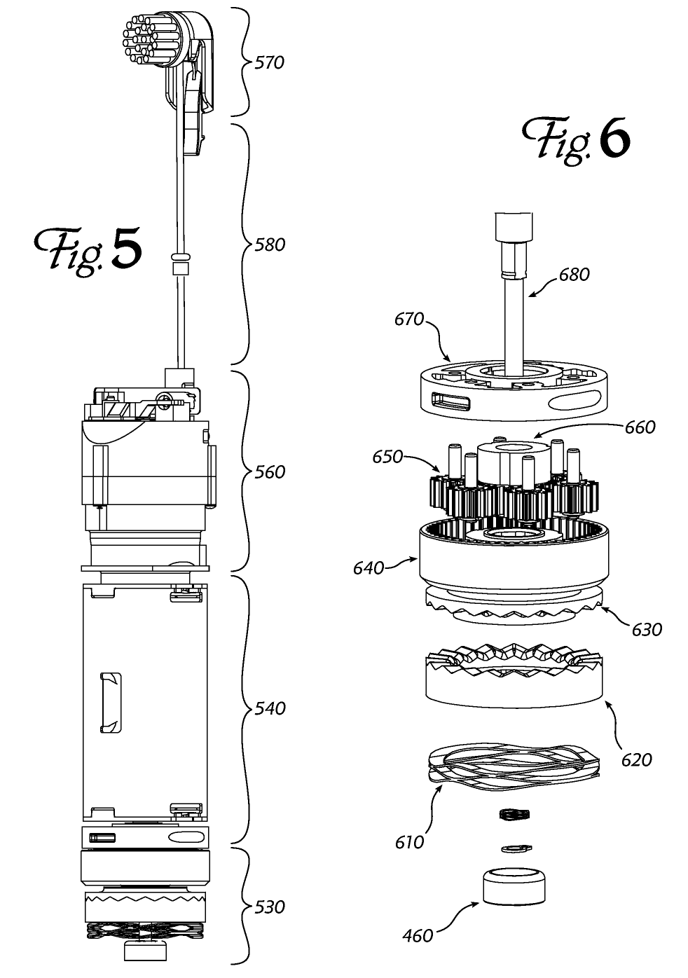

FIG. 5 shows the internal components of an embodiment of the invention after the exterior housing is removed. As mentioned with respect to previous figures, the general functional areas include the input gear train 530, the motor spring 540, the output gear train 560, and the oscillating brush head 570. Coupling 580 carries mechanical energy from the output gear train to the brush head.

FIG. 6 shows an exploded view of one exemplary input gear train. Coupler 460 is the input to the gear train, where it joins the winding handle. Spring washer 640 urges two complementary Hirth coupling plates 620, 630 together with a predetermined force. This force, combined with the angles between the Hirth “crown” points and the frictional coefficient of the coupling material, determine the maximum amount of torque that can be applied to the mechanism through the input winding handle. In other words, the Hirth coupling (610, 620, 630) serves as an input torque limiter (c.f. FIG. 2, 220).

The “output” side of the Hirth coupling (plate 630) is secured to the outer or ring gear 640 of a planetary gear set (640, 650, 660). A plurality of planet gears 650 turn between the ring gear 640 and a sun gear (difficult to see in this view, but the output collet of the sun gear is visible at 660). The planetary gear set is constructed to multiply input rotations of the winding handle by a factor of between about 2 and about 8 (i.e., the gear ratio of the planetary gear set is from about 1:2 to about 1:8). Because of the configuration of the winding handle, each winding twist by the user rotates through about ½ turn of the Hirth coupling. The planetary gear set multiplies that to produce around 1 to around 4 turns for compressing the motor spring. The planetary gear ratio may be increased to reduce the number of turns required to compress the spring; or the ratio may be reduced to limit the torque required of the user on each winding turn. Cover 670 keeps the planetary gear set components together, and axle 680 delivers the rotation-multiplied winding twists to the next section of the device.

In one embodiment, the input gear train may be provided with a ratchet, so that the user can make a charging twist, then rotate the handle back to its original orientation with negligible force so that it is ready for another charging twist. In another embodiment, the input gear train may be provided with two different gear paths, so that the motor spring is compressed by rotation of the handle in either direction. In a bidirectional charging embodiment, the gear ratio in each direction may be different, so that one direction charges with only a few high-torque twists, while the other direction requires more, lower-torque twists. Such an embodiment may be easily useable by both adults of ordinary grip strength, and children or infirm individuals who are unable to apply the ordinary torque to the winding mechanism.

The preferred embodiment is provided with a torque limiting mechanism, either between the winding handle and the input gear train (as shown in FIG. 6), or between the input gear train and the spring being compressed. A torque limiter may help prevent over-winding and accompanying damage to the gear train or energy storage components. A simple friction clutch may be designed to slip when a predetermined torque is reached, or a Hirth coupling may allow finer control of limit torque through choice of angles, joint materials, and spring compression force holding the joint together. A Hirth coupling may also provide audible or tactile feedback when the limit torque is reached, allowing the user to easily determine when the motor spring is fully compressed.

### Energy Storage

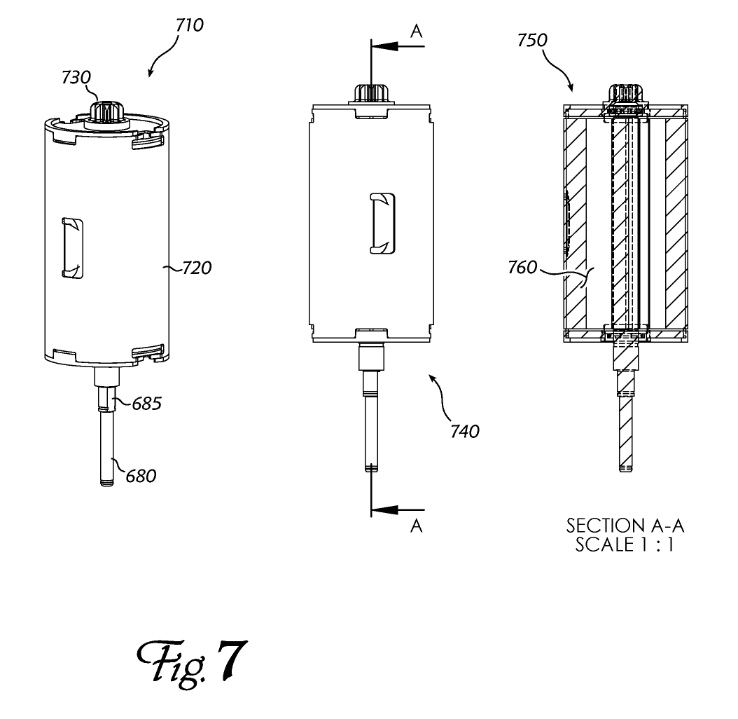

FIG. 7 shows a spring-motor module 710 that is suitable for use in an embodiment of the invention. Externally, the module is a fairly simple cylindrical shell 720, with an input shaft 680 (note flat 685 where the sun gear 660 of the input gear train grips the shaft), and an output gear 73o from which stored spring energy can be delivered. An orthogonal side view 740 is shown cut away at 750, but there is very little internal structure to be seen (760). In a preferred embodiment, a coil or scroll spring is disposed within the cylindrical shell. The spring may be compressed fully with about 6 turns (about 2 to 4 turns of the winder, multiplied by the input gear ratio), and is thereafter capable of delivering the stored energy at a relatively constant torque via the output gear 730.

In a preferred embodiment, the motor spring is a constant force spring, sometimes called a constant torque spring. Within its design operating range, a constant force or constant torque spring exerts a relatively consistent force against its load during most of its unwinding or energy-delivering operation. The consistent force relaxes the design constraints on subsequent mechanical stages, which need not account for widely-varying power delivery as the spring winds down.

### Output Gear Train

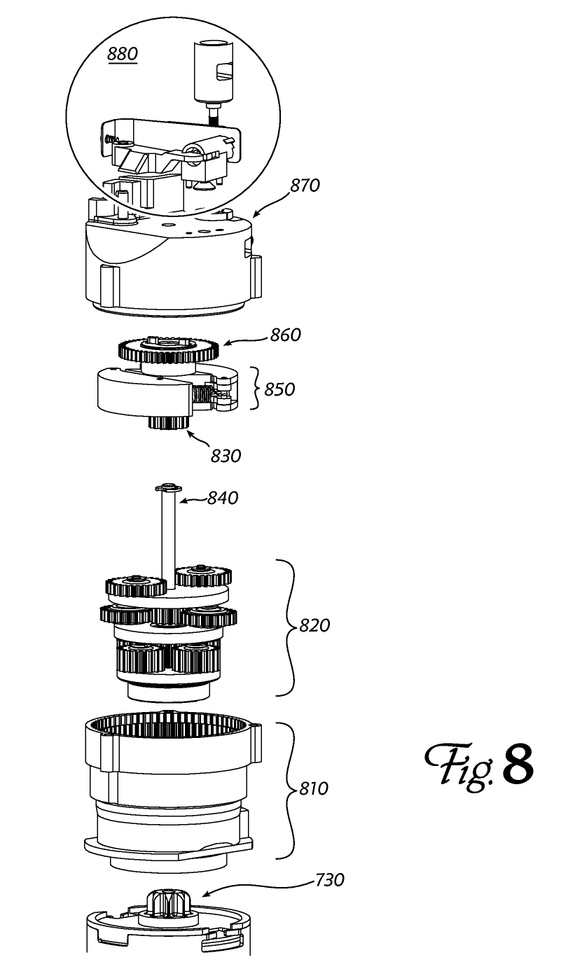

FIG. 8 shows an exploded view of the output gear train of an embodiment, starting with the output gear 730 of the spring motor. This serves as the sun gear of a multi-stage planetary gear set that multiplies the output rotations of the spring. A lower portion of the output gear train housing 810 comprises several ring gears, within which several planet and sun gear sets 820 run. The final sun gear 830 turns on shaft 840, and rotates at about 350 to 450 times the speed of the spring-motor gear 730. In a preferred embodiment, the output gear ratio is 420:1.

The multi-stage planetary speed multiplier (810, 820, 830) is coupled to an inertial speed limiter 850 (c.f. FIG. 2, 280) which is described in greater detail below. The speed limiter or governor 850 operates to keep the final output gear 860 turning at a relatively uniform rate as the spring motor returns its energy. (Without speed limiter 850, the toothbrush might operate very quickly at first, but then slow down as the spring relaxed.)

A cap or cover 870 encloses the output gear train and speed governor, and forms a base to support the final brush-drive mechanism 880.

### Speed Limiter (Governor)

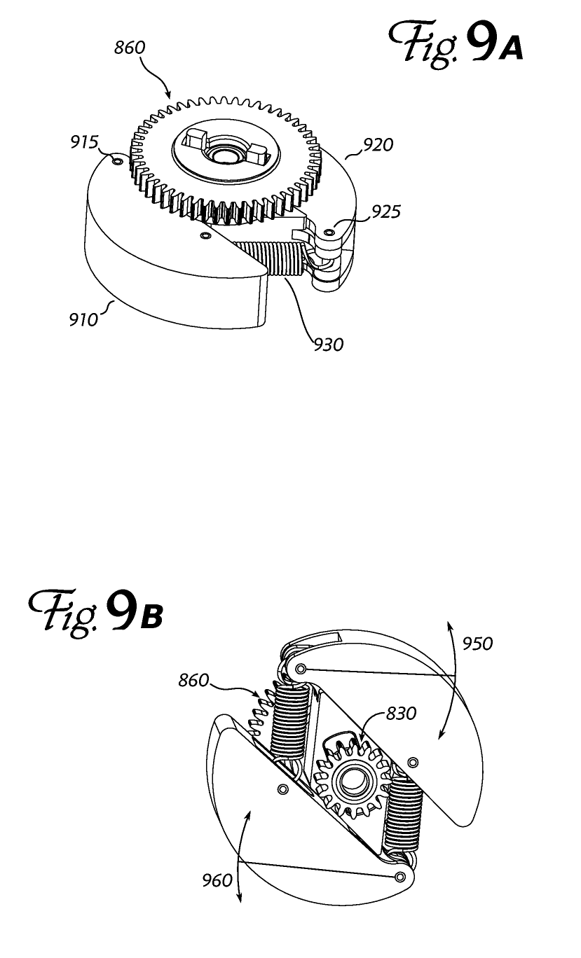

FIGS. 9A and 9B show top and bottom views, respectively, of the speed limiter (850 in FIG. 8). The final, speed-controlled output gear 860 is visible in FIG. 9A, while the sun gear 830 that is the last stage of the speed-multiplying planetary gear train is visible in FIG. 9B. Semicircular weights 910 and 920 are secured to and turn with gears 830, 860 via pivot pins 915 and 925, respectively. The weights swing out, 950 & 960, as the gears turn, but are pulled back in by springs 930. When gear 830 is turning rapidly, the weights swing out and may even drag against the inside of the output gear train cap 870, reducing the output gear speed. When gear 830 is turning more slowly, springs 930 pull the weights back towards the center axle 840, allowing the output gear train to turn more rapidly. In this way, the mechanism shown in FIGS. 9A and 9B stabilizes the output gear speed. Stabilizing the output gear speed is beneficial because it promotes more consistent tooth brushing, and it may also prolong run time by controlling energy release from the energy store.

### Brake

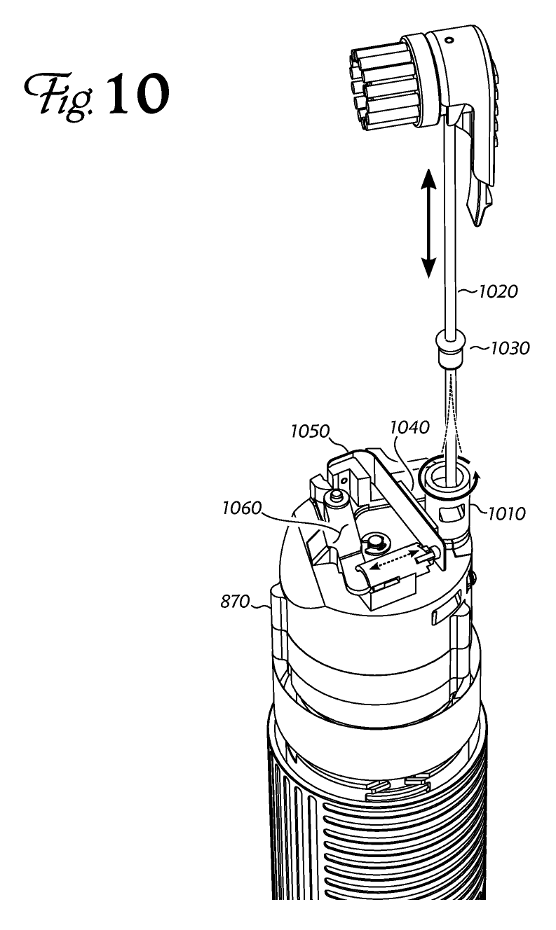

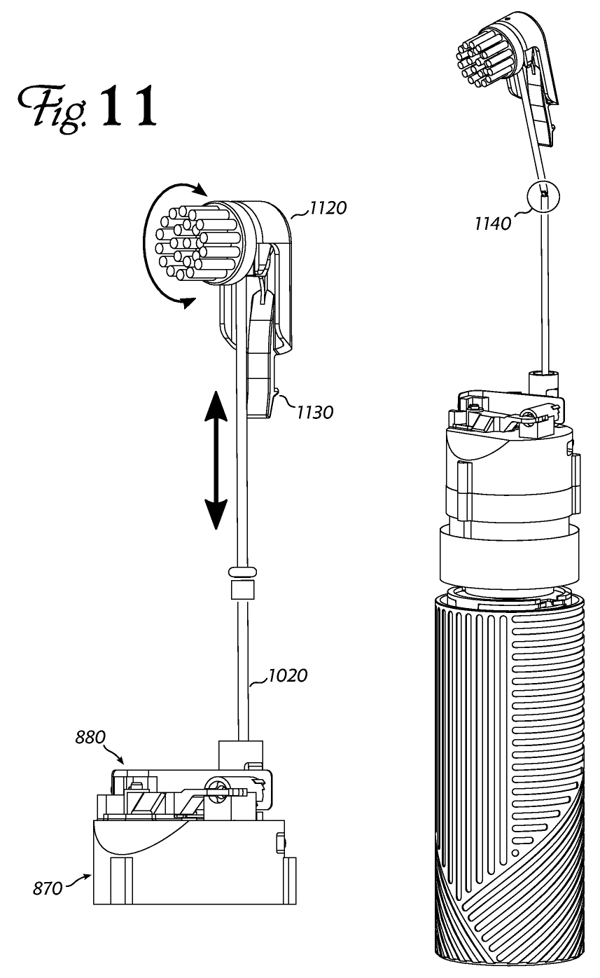

FIG. 10 shows another view of the output gear train of an embodiment. The output gear train cap 870 is in place, and an eccentric spinning cup is indicated at 1010. The final drive gears spin this cup rapidly, which causes the lower end of brush drive connecting rod 1020 to travel in a circle. The lower portion of connecting rod 1020 traces out a skewed cone, with bushing 1030 at the apex. Above bushing 1030, the connecting rod 1020 reciprocates (moves up and down). As explained above, the output gear train multiplies the rotation of the spring motor, so eccentric spinning cup 1010 turns very rapidly, but with little torque. Thus, its rotation can be interrupted relatively easily by pushing a brake pad 1040 against it. This stops the entire output gear train, effectively turning the powered toothbrush off. The brake pad 1040 is carried by a lightweight spring member 1050, such as a thin steel leaf. A bistable (click-on, click-off) mechanism 1060 pushes the spring forward so that the brake pad 1040 stops the spinning cup 1010; or allows the spring to pull the brake pad 1040 away from the cup 1010 so that the toothbrush begins oscillating or vibrating.

### Oscillating Brush

Finally, FIG. 11 shows some details of the brush-drive mechanism of an embodiment. Atop the output gear train cover 870 is a linkage 880 which converts the rotation of the final speed-controlled output gear 860 (not visible here) into a reciprocating motion of a brush drive connecting rod 1020, which travels up the narrow neck of the housing. Within the removeable brush head 1120, another linkage converts the reciprocating motion of the connecting rod to a suitable rotation, translation or sweeping motion of the brush bristles (in this Figure, the bristles rotate back and forth about an axis parallel to the bristles). The brush head is preferably secured to the narrow neck by a manually-operated clip 1130—when a brush has become worn or damaged, it may be removed and replaced. An embodiment may have an angled neck; in this case, a flexible joint like that shown at 1140 may be used to carry the reciprocating motion from the drive mechanism, through the angled neck and to the brush head. Other embodiments may use a rotary final-drive, e.g., connecting rod 1020 may itself rotate to carry motive power to the brush head, where gears or other suitable mechanisms convert the rotation into a desired brush motion.

The applications of the present invention have been described largely by reference to specific examples and in terms of particular allocations of functionality to certain mechanical structures and arrangements. However, those of skill in the art will recognize that a manually-wound, mechanical power toothbrush can also be constructed differently than the preferred embodiments herein described. Such variations and alternate implementations are understood to be captured according to the following claims.

We claim:

1. A powered toothbrush comprising:
a spring;
manually-operated winding means for compressing the spring;
drive means for controllably releasing compression of the spring; and
a brush coupled to the drive means so that the brush oscillates while the drive means is controllably releasing the compression of the spring.

2. The powered toothbrush of claim 1, further comprising:
a brake for preventing the drive means from controllably releasing compression of the spring while the brake is engaged.

3. The powered toothbrush of claim 1 wherein the spring is a motor spring.

4. The powered toothbrush of claim 1 wherein the winding means comprises a planetary gear set having a gear ratio between 1:2 and 1:8.

5. The powered toothbrush of claim 1 wherein the winding means comprises a torque limiter.

6. The powered toothbrush of claim 5 wherein the torque limiter is a Hirth coupling.

7. The powered toothbrush of claim 1 wherein the drive means comprises a planetary gear set having a gear ratio between 1:350 and 1:450.

8. The powered toothbrush of claim 1 wherein the drive means comprises an inertial speed limiter.

9. The powered toothbrush of claim 1 wherein the spring, the winding means and the drive means are contained within a substantially cylindrical housing.

10. A powered toothbrush comprising:
a roughly-cylindrical body having a lower portion, an upper end and a middle portion between said lower portion and said upper end, said upper end provided with a replaceable vibrating brush;
a constant-torque spring disposed within the middle portion;
an input gear train coupled between the lower portion and the constant-torque spring;
an output gear train coupled between the constant-torque spring and the replaceable vibrating brush; and
an output brake to prevent the output gear train from operating, wherein
rotating the lower portion around an axis of the roughly cylindrical body with respect to the middle portion activates the input gear train to cause winding of the constant-torque spring; and
disabling the output brake causes the constant-torque spring to drive the output gear train so as to activate the vibrating brush.

11. The powered toothbrush of claim 10, further comprising:
a speed governor coupled to the output gear train to limit a rate of operation of the output gear train to a predetermined rate.

12. The powered toothbrush of claim 10, further comprising:
a torque limiter coupled to the input gear train to prevent the input gear train from applying torque greater than a predetermined torque to the constant-torque spring during winding.

13. The powered toothbrush of claim 12 wherein the torque limiter is a Hirth coupling.

14. The powered toothbrush of claim 12 wherein the torque limiter is a friction plate coupling.

15. The powered toothbrush of claim 10 wherein the input gear train comprises a planetary gear set to convert a first angular rotation of the lower portion of the roughly cylindrical body into a different angular rotation for winding the constant-torque spring.

16. The powered toothbrush of claim 10 wherein the input gear train comprises a ratchet to convert rotation in only one direction into winding of the internal spring.

17. The powered toothbrush of claim 10 wherein the input gear train converts rotation in either direction of the lower portion of the roughly cylindrical body into winding of the constant-torque spring.

18. The powered toothbrush of claim 17 wherein a first gear ratio of rotation in a first direction is different from a second gear ratio of rotation in a second, different direction.

19. A powered toothbrush comprising:
a roughly-cylindrical housing having a central axis;
a motor spring contained within the roughly-cylindrical housing;
a winding cap at one end of the roughly-cylindrical housing, said winding cap capable of rotating around the central axis;
a winding gear train comprising a first planetary gear set coupled between the winding cap and the motor spring, said winding gear train having a gear ratio from about 1:2 to about i:8 and operative to convert a first angular rotation of the winding cap around the central axis into a second, different angular rotation of the motor spring;
an oscillating brush coupled to another end of the roughly-cylindrical housing;
a drive gear train comprising a second planetary gear set coupled between the motor spring and the oscillating brush, said drive gear train having a gear ratio from about 1:350 to about 1:450 and operative to convert a third angular rotation of the motor spring into an oscillating cycle of the oscillating brush;
an inertial speed limiter coupled to the drive gear train to prevent a rate of rotation of the third angular rotation from exceeding a predetermined maximum rate of rotation; and
a brake to prevent the drive gear train from operating to convert the third angular rotation of the motor spring into the oscillating cycle of the oscillating brush while the brake is engaged.
